(19) United States
(12) Patent Application Publication
(10) Pub. No.: US 2009/0319236 A1
(43) Pub. Date: Dec. 24, 2009

(54) METHOD FOR ANALYZING WIRELESS NETWORK LOCATED AT A TERRESTRIAL ENVIRONMENTS

(76) Inventors: Nathan Blaunshtein, Be'er Sheva (IL); Nathalie Yarkoni, Be'er Sheva (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/301,320

(22) PCT Filed: May 17, 2007
(86) PCT No.: PCT/IL07/00605

§ 371 Date: May 18, 2009

Related U.S. Application Data
(60) Provisional application No. 60/801,071, filed on May 18, 2006.

(51) Int. Cl. H04W 16/00; G06F 17/50

(52) U.S. Cl. 703/1; 703/13; 455/446

(57) ABSTRACT

A method for designing and analyzing a wireless network located at terrestrial environments by using a method based on an algorithm utilizing a 3D stochastic multi-parametric (3DSM) model of a terrain area designated for the wireless network. The algorithm is used for designing a wireless network operable in the area and analyzing the performance of the wireless network. The 3D model methodology is applicable for calculating average field intensity in different outdoor environments which is derived for a three-dimensional geometry model and yields higher precision calculations for the mixed residential or sub-urban areas by considering the wide range of vertical and horizontal dimensions of houses and trees.

### FIELD OF THE INVENTION

The present invention generally relates to analysis of outdoor wireless networks.

The present invention particularly relates to designing a wireless network and predicting quality of service and data stream parameters of outdoor stationary and mobile radio communication links.

### BACKGROUND OF THE INVENTION

As future systems evolve, multibillion investments and yearly expenses, operations research methods for mobile networks potentially have a huge economical and technological impact. Stochastic analysis of mobile communications provides an opportunity for incorporating operations research methods in the design of these systems. In clear contrast to rapid development of mobile communication networks, capacity available for mobile networks is severely limited and insufficient to accommodate demand. To increase the network capacity, the area covered by a provider is divided into cells served by cell-transceivers transmitting at limited power. Evaluation of loss probabilities and related performance measures requires the combined analysis of telecommunications models for channel-availability, outdoor terrain and of traffic models for subscriber-mobility.

Existing commercially available link analysis tools use various techniques for the analysis. For example, the empirical Okumura-Hata model, the Bertoni model and the Walfish-Ikegami model require signal intensity decay law versus the range between the terminal antennas is derived by the following mathematical relationship:

L(I)∝d^{-γ} (1.1)

Wherein

γ=26−40.

The abovementioned approaches are only relevant for specific scenarios, with accuracy of 10-15 dB relative to experimental data.

Link budget estimation which is a table of link performance specifications is a parameter sought for in mobile cellular networks. Link budget are based on experimental data obtained for various terrestrial communication links. Steele, R., for example describes in his paper (Mobile Radio Communications) a method for obtaining link budget called: The Steele's approach. According to this concept, the expected median signal power at the moving vehicle/subscriber (MV/MS) must be derived, first of all, for determining the radio coverage of a specific base station (BS) and the interference tolerance for the purpose of cellular map construction. As suggested by Steele's approach, the total signal power at the receiver, P_{RX}, is also subjected to slow fading or shadowing and fast fading, which are mainly caused by the characteristic terrain features in the vicinity of BS and MV. Usually, when designing the network power budget and the coverage area pattern, the slow and fast fading phenomena are taken into account, introducing a shadow fading margin L_{SF}=2σ_{Sh}, where σ_{Sh} is the standard deviation of shadowing, as suggested in Steele's approach and in Rappaport, T. S., (Published in: “Wireless Communications”), and a fast fading margin, L_{FF}, as functions of the range between BS and MV.

A shadow fading margin, which is typically in the range of about 1% to 2% of the slow fading lognormal probability distribution function (PDF), and a fast fading margin, which is typically predicted to be the in the range of about 1% to 2% of the fast fading Rayleigh or Rice PDF, may be taken into account simultaneously or separately in the link budget design depending on the worst-case scenario in the concrete communication channel. This situation is often referred to as “fading margin overload” resulting in a very low-level received signal almost entirely covered in noise. The probability of such worst cases determines the event of how rapidly the signal level drops below the receiver's noise floor level (NFL). The probability of such an event was predicted in Steele's approach as a sum of the individual margin overload probabilities, the slow and the fast, when the error probability is close to 0.5, since the received signal is at the NFL.

According to Steele's approach and Rappaport, the slow fading margin is determined by:

L_{SF}=2σ_{Sh}=10-15 dB.

There Assuming the Rician fast fading PDF.

When using a somewhat more general PDF for multi-path channel prediction, with the Rician parameter K=5-10 and a fast fade margin overload probability of 1% depicted in FIG. 1 illustrating a case when a line of sight (LOS) exists between the transmitter of the channel and a receiver. A fast fading margin can be obtained by using the so-called the Rappaport's approach by the value:

L_{FF}=5-7 dB

A further strict concept of how to obtain the slow and fast fade margins was proposed by Saunders, S. R., (published in: “Antennas and Propagation for Wireless Communication Systems”) and called: “The Saunders approach”. According to the Saunders approach, the effect of slow fading or shadowing can be described as a difference between the median path-loss, as predicted by any standard propagation model and a component which depends on the characteristics of the nearby propagation environment (local clutter). The PDF of slow fading is also defined as a Gaussian process with a zero-mean Gaussian variable L_{SF} and with a standard deviation of shadowing and the information of a σ_{L}, is required for obtaining the shadow fade margin.

Using concept described in Saunders' approach. One can also estimate the fast fade margin, L_{FF}, by using the Rican PDF distribution of such parameter.

Using a new notation results:

$$PDF ( {L}_{FF} ) = \frac{2 {L}_{FF}}{{( rms )}^{2}} exp \{ - \frac{{L}_{FF}^{2}}{{( rms )}^{2}} \} \cdot exp ( - K ) \cdot {J}_{0} ( \frac{2 {L}_{FF}}{rms} \sqrt{K} ) \qquad ( 2.1 )$$

where,

rms=\sqrt{2}·σ_{F}, σ_{F} is the variance of fast fading, which can be defined as following:

$${σ}_{F} = {\int }_{0}^{∞} {x}^{2} \cdot p ( x ) d x - {( {\int }_{0}^{∞} x \cdot p ( x ) \cdot d x )}^{2} \qquad ( 2.2 )$$

Using derivations carried out for Wireless Communication Systems, in the “Handbook of Engineering Electromagnetics”, we finally get:

$${σ}_{F} = [ 2 \cdot {( rms )}^{2} \cdot {e}^{- K} ] \cdot {[ \begin{matrix}\begin{matrix}\frac{1}{2} \cdot {e}^{K} {\int }_{0}^{∞} {y}^{3} \cdot {e}^{- {y}^{2}} \cdot \\ {I}_{0} ( 2 \cdot \sqrt{K} \cdot y ) \cdot d y -\end{matrix} \\ {( \begin{matrix}{\int }_{0}^{∞} {y}^{2} {e}^{- y 2} \cdot \\ {I}_{0} ( 2 \cdot \sqrt{K} \cdot y ) \cdot d y\end{matrix} )}^{2}\end{matrix} ]}^{1 / 2} \qquad ( 2.3 )$$

So, as above for slow fading, we have here the loss due to fast fading, which can be expressed as:

L_{FF}=10·log₁₀(σ_{F}) [dB] (2.4)

The Ricean parameter K is presented as the ratio of LOS component (deterministic part of the total signal) and NLOS component (random part of the total signal), i.e.,

$$K = \frac{LOS - component}{NLOS - component} = \frac{〈 {I}_{co} 〉}{〈 {I}_{inc} 〉} \qquad ( 2.5 )$$

[symbol]

, [symbol] are the coherent and incoherent parts of the total field intensity, respectively. When parameters rms and K are known a-priori L_{FF} can be derived. According to Saunders' approach the link power budget proposed has two variants of link-budget design prediction. The First variant describes Estimation of the slow fade margin, z and the derivation of the median path loss, L̅, by using well-known propagation models, and using the maximum acceptable path loss, Lₘ, as well as the range between concrete terminal antennas. The knowledge of which is done for the performed wireless system. Estimation of fast fade margin can be done, if the standard deviation and the Ricean parameter K are known for the concrete propagation channel and wireless system. The Second variant describes estimation of the slow fade margin, z, and the range between concrete terminal antennas using derivation of the median path loss, L̅, through well-known propagation models, and using the standard deviation of slow fading, σ_{L}, as well as the percentage of the success communication for the concrete wireless system performed.

As for the fast fade margin, L_{FF}, it can be obtained if the standard deviation of fast fading, σ, or rms, as well as the probability of the successful communication are known for the concrete wireless system. These approaches are not precise and require a great amount of measurements and statistical analysis.

To arrange the effective splitting of tested built-up area at cells, the designers need strict information about the law of signal power decay for the concrete situation in the site of service, i.e., need strict link budget analysis of propagation situation within each communication channel, as well as full radio coverage of each subscriber located LOS or NLOS conditions in areas of service, giving exact clearance between subscribers within each cell. Based on precise knowledge of propagation phenomena inside the cellular communication channels, it is easy to optimize cellular characteristics, such as radius of cell, reuse factor Q, channel interference parameter C/I, etc. First we will discuss the question of clearance between arbitrary subscribers within the cell and will introduce the recipe of cell radius prediction for the concrete propagation situation. In our further discussions, we appeal to urban and sub-urban environments, for which more difficult can be predicted all parameters of cell pattern mentioned above.

As indicated in the preceding section, a better clearance between the base station (BS) and moving subscribers (MS) in clutter conditions can be reached only for LOS conditions between them. In this case, R_{cell}, cannot be larger than the break point range, r_{B}, at which the decay of the signal is changed from γ=2 (as in free space propagation) to γ=4 (propagation above flat terrain). This means that the signal decay between BS and each MS in a cell of radius R_{cell}≦r_{B} is a function of R_{cell}⁻². Beyond the break point the signal decays versus the range between terminal antennas, is determined by path-loss slope parameter γ and depending on the concrete situation in the urban scene and may be proportional to R^{-γ} with γ>2 (γ=4−6). Other models of rural and mixed residential areas with a rare buildings' distribution the path-loss slope parameter γ are denoting a change of received signal decay from γ=2.5 to γ=4.0, which is in agreement with existing propagation models of the preceding section. Apparently, field attenuation in these kinds of area is faster than that in LOS conditions of free space.

Co-channel Interference, which is another factor of link attenuation, is determined by the following C/I calculation derived from the classical radio theory expression of:

$$\frac{C}{I} = 10 log [ \frac{1}{6} ( \frac{{D}^{γ}}{{R}_{cell}^{γ}} ) ] \qquad ( 3.1 )$$

Where
D is the reuse distance between co-interferer cells operated with the same frequency bands.
γ Is a factor of signal strength attenuation inside and outside the cell.

C/I-ratio is derived by a heuristic approach from mathematical models by accounting the Walfisch-Ikegami model (WIM) of signal power decay in urban environment.

Frequency assignment is determined by a heuristic algorithm based on cell configuration, which does not follow the classical hexagonal-cell homogeneous concept with a periodic frequency reuse pattern. This algorithm is based on the binary constraints between pair if transmitters presented in the following form:

|fᵢ−fⱼ|>k, k≧0 (4.1)

where

fᵢ and fⱼ are frequencies assigned to transmitters i and j, respectively.

Different configurations of the cellular pattern are analyzed for channel (frequency) assignment purposes with applications to real non-regular non-uniform radio networks, mobile and stationary, considering: Cellular maps with different dimensions of cells, cellular maps with irregular shapes of cells and cellular maps with certain level of inter-cell over-lapping. These configurations of cells entail using the following expression:

$${( \frac{C}{I} )}_{i} = \frac{{R}_{i}^{- 4}}{{\sum }_{j ∈ {M}_{i}} {d}_{ij}^{- 4}} \qquad ( 5.1 )$$

The expression is based on a two-ray propagation model (“flat terrain” model) with γ=4. All the notations are changed here from those used in to be unified with those used in this patent presentation. Here Rᵢ is a radius of cell i; Mᵢ is the set of all the cells (excluding cell i) which use the same bandwidths (channels) as cell i; dᵢⱼ is the worst case distance between interfering cell j and cell i. The latter can be found as

dᵢⱼ=\sqrt{(xᵢ−xⱼ)²+(yᵢ−yⱼ)²}−Rᵢ (5.2)

where

(xᵢ, yᵢ) and (xⱼ, yⱼ) are the Cartesian coordinates of base stations of cells i and j, respectively. Using this simplest propagation model, in the co-channel interference constraint was obtained for C/I threshold α=1/β=18 dB:

$${\sum }_{j ∈ {M}_{i}} \frac{{d}_{ij}^{- 4}}{{R}_{i}^{- 4}} \leq β \qquad ( 5.3 )$$

The model can be enhanced by introducing adjacent channel interference is

adj_factorₖ=−α(1+log₂ k)

k is the bandwidth separation in number of channels, between the adjacent channel frequency and central frequency of the corresponding channels.

a is typically 18 dB.

A fixed wireless access system (FWA) or a mobile wireless access system (MWA) are anticipated to have degraded quality of service (QOS) due to low link reliability caused by radio wave dispersion and signal interfering conditions (i.e., shadowing, multi-path interference, multi-carrier interference and variable channel characteristics). A high service demand characterized by a grade of service (GOS) has to be still maintained by the service provider, while considering subscriber's signal degradation and with minimal network resources.

A classical GOS analysis for circuit-switched (voice) traffic uses the Erlang-B or Erlang-C formulas, which is a special case of the birth and death (B&D) expression for calculating the total system capacity and the probability of working without call congestion.

Erlang-B formula is justifiable of using only in cases where all users have access to all resources of the system (full-availability). In wireless systems, due to propagation limitations, such as obstacles and wave attenuation, some users have limited access to the system resources (limited-availability), hence Erlang-B formula is not usable in those cases.

Moreover so, in FWA systems, one user gets service from one cell. The user is part of a user group that is covered by one or more cells. If one user has optional access to more than one cell, the system has to allocate the user to one of these cells in order to achieve an optimal grade-of-service known as load-balancing. The decision rule of user allocation refers to the load-balancing algorithm.

The capacity of a communication channel is defined as the traffic load of data in bits per second. It is accepted to use Shannon-Hartley formula, in order to calculate the capacity of the channel:

C=B_{w} log₂[1+SNR] (6.1)

SNR is the signal-to-noise ratio for the channel with the additive white Gaussian noise (AWGN). The ratio is usually measured in dB.

$$S N R = 10 log ( \frac{{P}_{R}}{{N}_{R}} ) = {P}_{R [ dB ]} - {N}_{R [ dB ]} \qquad ( 6.2 )$$

C is the channel capacity in bits per second,

B_{w} is the one-way transmission bandwidth of the channel in Hz, Another criterion of efficiency of the communication channel can be defined by use other data stream parameter such as the bit error rate (BER). The BER usually is achieved at a practical communication system. For example, for an encoded BPSK system, the BER is given by:

$$BER = \frac{1}{2} {\int }_{0}^{∞} p ( x ) erfc ( \frac{S N R}{2 \sqrt{2}} x ) d x \qquad ( 6.3 )$$

p(x) is the probability density function

erfc() is the well-known ‘error function’.

Effects of interference can be regarded as another source of effective noise. Thus for K-carrier system, each carrier/subscriber of number i can affect the desired subscriber as an additional interferer which can be described by a Gaussian-like noise. Then, according to Rappaport, we can write:

$$C = {B}_{w} {log}_{2} [ 1 + \frac{S}{{N}_{0} {B}_{w} + {\sum }_{i = 1}^{K - 1} {N}_{i}} ] \qquad ( 6.4 )$$

Nᵢ is the power of i-subscriber, which is considered additive noise of the discussed subscriber.

A cellular network design is very demanding when considering the high service demand required by a service provider at all locations coupled with the network limited resources. The core design tool for the network design is cellular network analysis system. Consequently, a network analysis system capable of closely estimating faithfully network characteristics under all terrain conditions close to is still a long felt need.

### SUMMARY OF THE INVENTION

It is the object of this invention to disclose a method for designing and analyzing a wireless network located at a terrestrial environments, comprising: creating a 3D stochastic multi-parametric (3DSM) model of a terrain area designated for a wireless network, designing a wireless network operable in said area and analyzing the performance of said wireless network.

wherein creating said 3DSM model of said terrain, is yielding design and analysis parameters of said network that are substantially equal to corresponding parameters obtained by measuring.

Another object of the present invention is to disclose a method defined by any of the above wherein the step of creating said 3DSM model consists of building overlay profile of obstructions affecting the distribution of scattered radio waves from horizontal and vertical dimensions of said obstructions; wherein said obstructions are selected form a group of structures located within a network area consisting of building, trees, hills, fixed structures or any combination thereof.

Another object of the present invention is to disclose a method defined by any of the above wherein the step of creating said 3DSM model distribution is provided for mixed residential areas, sub-urban areas, urban areas or any combination thereof.

Another object of the present invention is to disclose a method defined by any of the above further comprising adding a multiplicative noise term which is used for emulating fading phenomena, to the real white noise term.

Another object of the present invention is to disclose a method defined by any of the above wherein designing said network comprises calculating minimum cell radius from said 3DSM model.

Another object of the present invention is to disclose a method defined by any of the above wherein said calculating step of said minimum cell radius follows a calculating step of signal fading.

Another object of the present invention is to disclose a method defined by any of the above wherein said calculating step of said minimum cell radius follows a calculating step of link path loss.

Another object of the present invention is to disclose a method defined by any of the above wherein designing said network comprises calculating co-channel interference constraint.

Another object of the present invention is to disclose a method defined by any of the above wherein designing said network comprises calculating a grade of service (GOS) of said wireless network;

Another object of the present invention is to disclose a method defined by any of the above wherein said analyzing step comprising calculating said network bit error rate (BER);

Another object of the present invention is to disclose a method defined by any of the above wherein said analyzing step comprising calculating said network quality of service (QOS);

Another object of the present invention is to disclose a method defined by any of the above wherein said analyzing step comprising calculating said network capacity;

Another object of the present invention is to disclose a method defined by any of the above wherein said analyzing step comprising calculating said network spectral efficiency.

Another object of the present invention is to disclose a method defined by any of the above wherein any of said calculating steps is substantially matched with real experiments.

Another object of the present invention is to disclose a method defined by any of the above wherein said step of designing comprises obtaining standard deviation of slow fading, σ_{L}, is performed either for single diffraction and double diffraction scenarios.

Another object of the present invention is to disclose a method defined by any of the above wherein said step of designing comprises obtaining said fade margin is performed both in the cases of slow and fast fading.

Another object of the present invention is to disclose a method defined by any of the above adapted for radio mapping by distinguishing areas through attenuation after predicting said attenuation according to parameters selected from a group consisting of terrain elevation data, a clutter map, the effective antenna height, antenna pattern or directivity and its effective radiated power (ERP), operating frequency or any combination thereof.

Another object of the present invention is to disclose a method defined by any of the above especially adapted for designing of cellular maps.

Another object of the present invention is to disclose a method defined by any of the above especially adapted to be utilized in a wireless technology selected from CDMA, FDMA, TDMA, GSM, UMTS, WCDMA, or any technologies derived thereof.

Another object of the present invention is to disclose a method defined by any of the above especially useful for improving channel allocation.

Another object of the present invention is to disclose a method defined by any of the above especially adapted to 802.11 wireless network or any protocol based on the same.

### BRIEF DESCRIPTION OF THE FIGURES

In order to understand the invention and to see how it may be implemented in practice, and by way of non-limiting example only, with reference to the accompanying drawing, in which

FIG. 1a illustrates a non-scaled two dimensional network schematic under line of site (LOS) conditions, according to an embodiment of the present invention.

FIG. 1b illustrates a non-scaled two dimensional network schematic under non line of site (NLOS) conditions, according to an embodiment of the present invention;

FIG. 1c illustrates a non-scaled two dimensional network schematic under NLOS multi-path conditions, according to an embodiment of the present invention;

FIG. 2 illustrates a non-scaled two dimensional network schematic under LOS conditions when the terminal antennas are along the street, according to an embodiment of the present invention;

FIG. 3a illustrates a non-scaled top view network schematic under LOS conditions along a street when the BS antenna is above roof top and the MS antenna under roof top, according to an embodiment of the present invention;

FIG. 3b illustrates a non-scaled vertical cross section schematic of the antennas in FIG. 3a, according to an embodiment of the present invention;

FIG. 4 illustrates a radio map of an experimental site in Stockholm, according to an embodiment of the present invention;

FIG. 5a illustrates an aerial view of Israel's diamond exchange building area in of Ramat Gan, according to an embodiment of the present invention;

FIG. 5b illustrates the radiation pattern of the antennas located in Israel's diamond exchange building area in of Ramat Gan, according to an embodiment of the present invention;

FIG. 6 illustrates an attenuation slope map of Israel's diamond exchange building area in of Ramat Gan, according to an embodiment of the present invention;

FIG. 7 illustrates a radio map of Israel's diamond exchange building area in of Ramat Gan, according to an embodiment of the present invention;

FIG. 8a illustrates a graph of K-factor as a function of distance between BS and MS respectively at f₀=900 MHz and 1800 MHz in a suburban environment, according to an embodiment of the present invention;

FIG. 8b illustrates a graph of K-factor as a function of distance between BS and MS respectively at f₀=900 MHz and 1800 MHz in a urban environment, according to an embodiment of the present invention;

FIG. 9a illustrates a graph of number of channels versus the number of interferers for a non-overlapping case when R_{cell}=100 m, according to an embodiment of the present invention;

FIG. 9b illustrates a graph of number of channels versus the number of interferers for a overlapping case when R_{cell}=250 m, according to an embodiment of the present invention;

FIG. 9c illustrates a graph of number of channels versus the number of interferers for a non-overlapping case when R_{cell}=250 m, according to an embodiment of the present invention;

FIG. 10 illustrates a schematic of antennas coverage areas in a contained area case [A] and an overlapping area case [B], according to an embodiment of the present invention;

FIG. 11 illustrates a flowchart of the proposed GOS derivation algorithm, according to an embodiment of the present invention;

FIG. 12 illustrates a graph of GOS and network load as a function of number of users according to an embodiment of the present invention;

FIG. 13 illustrates a graph of spectral efficiency as a function of K-factor, according to an embodiment of the present invention;

FIG. 14 illustrates a graph of BER as a function of K, according to an embodiment of the present invention, and

FIG. 15 illustrates a graph of BER as a function of C, according to an embodiment of the present invention;

FIG. 16 illustrates a flow chart of the analysis method, according to an embodiment of the present invention;

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide an internal engine accommodating high efficiency, high power and high engine capacity.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment or invention. Furthermore, the particular features, structures, or characteristics may be combined in any suitable manner in one or more embodiments.

The system of the present invention is usable for analyzing radio propagation in various environments and various antenna base station (BS) antenna elevation and moving subscriber's (MS) antenna elevation with respect to obstructions surrounding for network design and maintenance purposes. The different environments are selected from a group consisting of residential, sub-urban and urban outdoor environments and any combination thereof.

The system of the present invention exploits a methodology which defeats certain restrictions and shortcomings of presently available cellular network analysis systems by new enhancements and improvements of the system in the present invention. The system comprises enhancements and extensions to existing systems by utilizing a stochastic and multi-parametric approach considering two types of areas: mixed residential area having low buildings with trees and vegetation and urban area containing mostly high buildings in a dense built-up area.

The average field intensity in different outdoor environment is derived for a three-dimensional (3D) geometry model, yielding higher precision calculations for the mixed residential or sub-urban areas by considering the wide range of vertical and horizontal dimensions of houses and trees as opposed with the commercially available systems.

$$For \\ 〈 {I}_{inc} 〉 = \frac{Γ}{8 π} \cdot \frac{λ \cdot {l}_{h}}{{λ}^{2} + {[ 2 π {l}_{n} \overline{L} {γ}_{0} ]}^{2}} \cdot \frac{λ \cdot {l}_{v}}{{[ 2 π {l}_{v} {γ}_{0} ( \overline{h} - {z}_{1} ) ]}^{2}} \frac{( {z}_{2} - \overline{h} )}{{d}^{3}} \qquad ( 7.1 )$$

lᵥ and lₕ are correspondingly vertical and horizontal dimensions with respect to a reference plane of an obstruction.

Considering the distribution of scattered waves from the horizontal (lₕ) and vertical (lᵥ) axis of obstruction's plane, allows accounting various dimensions of the obstructions, such as houses, trees or hills.

Similarly, the coherent part of the average total field intensity is obtained by:

$$〈 {I}_{co} 〉 = exp {\{ - {γ}_{0} d \frac{\overline{h} - {z}_{1}}{{z}_{2} - {z}_{1}} \} [ \frac{sin ( {kz}_{1} {z}_{2} / d )}{2 π d} ]}^{2} \qquad ( 7.2 )$$

For the urban environments, the expression for the incoherent part of the total field intensity can be presented, considering single scattering and diffraction from buildings' corners and rooftops (i.e., for 3-D case) and the buildings' overlay profile F(z₁, z₂).

$$〈 {I}_{inc 1} 〉 = \frac{Γ λ {{l}_{v} [ ( λ d / 4 {π}^{3} ) + {( {z}_{2} - \overline{h} )}^{2} ]}^{1 / 2}}{8 π [ {λ}^{2} + {( 2 π {l}_{v} {γ}_{0} F ( {z}_{1} , {z}_{2} ) )}^{2} ] {d}^{3}} \qquad ( 7.3 )$$

The corresponding formula for double scattering and diffraction is given by:

$$〈 {I}_{inc 2} 〉 = \frac{{Γ }^{2} {λ}^{3} {l}_{v}^{2} [ ( λ d / 4 {π}^{3} ) + {( {z}_{2} - \overline{h} )}^{2} ]}{24 {{π}^{2} [ {λ}^{2} + {( 2 π {l}_{v} {γ}_{0} F ( {z}_{1} , {z}_{2} ) )}^{2} ]}^{2} {d}^{3}} \qquad ( 7.4 )$$

The coherent part of the total field intensity can now obtained as:

$$〈 {I}_{co} 〉 = exp \{ - {γ}_{0} d \frac{F ( {z}_{1} - {z}_{2} )}{( {z}_{2} - {z}_{1} )} \} \frac{{sin}^{2} ( {kz}_{1} {z}_{2} / d )}{4 {π}^{2} {d}^{2}} \qquad ( 7.5 )$$

F(z₁, z₂) is a relief function which is consisting of an n^{th} power polynomial.

For n<1 the polynomial is applicable to a scene with higher buildings.

For n>1 the polynomial is applicable to a scene with lower buildings.

For n=1 the polynomial equals ( h̅−z₁).

Using the relief function yields calculated field results of higher accuracy hence simulating more realistically network performance.

Furthermore, these expressions describe the frequency dependence of the propagation process inside the layer of city buildings:

˜f^{-q} with q<0 is the function for frequencies in the VHF-band and the lower part of the UHF-band (f<<1 GHz).

˜f^{-q} with q>0 is the function for the UHF-band and higher (f>0.5 GHz). The total wave field intensity from the transmitter is a superposition of a scattered (incoherent) spectrum <I_{inc}> described for mixed and sub-urban and urban areas, and a coherent spectrum <I_{co}> of total field energy.

For mixed residential areas

<Iₜₒₜₐₗ>=<I_{co}>+<I_{inc}> (7.6)

For urban areas

<Iₜₒₜₐₗ>=<I_{co}>+<I_{inc1}>+<I_{inc2}> (7.7)

and the corresponding path loss in dB is given by

L=10 log └λ²(<I_{co}>+<I_{inc}>)┘ (7.8)

L=10 log [λ²(<I_{co}>+<I_{inc1}>+<I_{inc2}>)] (7.9)

The attenuation slope parameter γ in the urban scene with randomly distributed buildings placed on rough terrain related to the case when [symbol] I_{inc} [symbol] > [symbol] I_{co} [symbol] is:

γ=2.5−3.0 (7.10)

For the case [symbol] I_{inc} [symbol] < [symbol] I_{co} [symbol] , since I₂₈ ˜d⁻²·exp(−αd)≈(d⁻²-d⁻⁵) we obtain, depending on the parameter α and distance d much widely range of attenuation slope parameter of: γ=2.0-5.0

These pass loss calculations are based on empirical, semi-empirical, statistical and analytical 2-D models, determine the path loss dependence on the range between two terminal antennas at the two ends of an outdoor communication link, and hence derives radio coverage of each zone serviced by these terminal antennas.

The second main parameter of the outdoor link performance is the link budget. There are some approaches that usually used in wireless communication for link budget performance mentioned above in item (b). We will mention the existing concepts usually used in practice of link budget design.

First of all, we determine parameters of communication link budget according to well-known concepts according to which the link power budget, that is, the total path loss inside the communication link, consists three main terms which satisfy three independent statistical processes and then are described by three independent characteristics of the signal power decay: the median path loss or the mean signal power decay along the radio path, L̅, which describe the probability to obtain the real signal power decay over 50% of locations and during 50% of time inside the test area, the slow fading or the characteristic of shadowing, L_{SF}, and the characteristic of fast fading, L_{FF}, e.g.,

L_{Link}= L̅+L_{SF}+L_{FF} (7.11)

As was shown in prior researches, these characteristics in general vary as a function of propagation range between terminal antennas, operating frequency, spatial distribution of natural and man-made obstructions placed surrounding these antennas, vehicles' speed and antennas' height with respect to obstructions, etc.

Link budget is one of principal cellular network parameters, derived by the system of the present invention and used for setting up and maintenance of a cellular network. The 3-D simulation technique described in the subsequent section, determines also path loss, by averaging the characteristics of signal energy attenuation and the effects of fading caused by shadowing due to diffraction from building rooftops or corners (large-scale fading), and multiple scattering phenomena (small-scaled fading). The link budget calculation step considers only link transmission characteristic and does not regard terminal antennas' characteristics. The parameters of the terminal antennas, BS and MS, are used in the system analysis by antenna gains, G_{BS} and G_{MS}, respectively.

The term ‘3D stochastic multi-parametric (3DSM) model’ refers hereinafter in a non limiting manner to a methodology for calculating average field intensity in different outdoor environment which is derived for a three-dimensional (3D) geometry model and yielding higher precision calculations for the mixed residential or sub-urban areas by considering the wide range of vertical and horizontal dimensions of houses and trees as opposed with the commercially available systems.

The term ‘obstruction’ refers hereinafter in a non-limiting manner to objects located within a wireless network terrain which affect signal levels at a mobile subscriber location.

The term ‘BS’ is an acronym of base station.

The term ‘MS’ is an acronym for mobile subscriber.

The term ‘building overlay profile’ refers hereinafter in a non-limiting manner to the 3D surface representing the buildings and other objects in the wireless network terrain, according to the 3DSM model methodology.

The term ‘multiplicative noise term’ refers hereinafter in a non-limiting manner to noise value according to the methodology of the method algorithm, added to the common white noise for simulating the effect fading.

The term ‘fading’ refers hereinafter in a non-limiting manner to signal level variations due to multi-path effects. Fading consists of a slow fading component and a fast fading component.

The term ‘co-channel interference’ refers hereinafter in a non-limiting manner to received signal interference caused by a signal of another channel.

The term ‘capacity’ refers hereinafter in a non-limiting manner to the traffic load of data in bits per second. It is accepted to use Shannon-Hartley formula, in order to calculate the capacity of the channel:

The term ‘spectral efficiency’ refers hereinafter in a non-limiting manner to the actual bandwidth of the of a link channel as a function of signal to noise ratio.

The term ‘CDMA’ refers hereinafter in a non-limiting manner to code division multiple access is a form of multiplexing and a method of multiple access that divides up a radio channel by using different pseudo-random code sequences for each user.

The term ‘FDMA’ refers hereinafter in a non-limiting manner to frequency division multiple access communication technology share the radio spectrum by allocating users with different carrier frequencies of the radio spectrum.

The term ‘TDMA’ refers to time division multiple access.

The term ‘GSM’ refers to Global System for Mobile communications which is the mostly widely used mobile phone communication standard.

The term ‘UMTS’ refers to Universal Mobile Telecommunications System is one of the third-generation (3G) mobile phone technologies.

The term ‘WCDMA’ refers to Wideband Code Division Multiple Access which a type of 3G cellular network networks deployed worldwide and which is a wideband spread-spectrum mobile air interface that utilizes the direct sequence Code Division Multiple Access method to achieve higher speeds and support more users.

The term ‘802.11’ refers to IEEE 802.11 denotes a set of Wireless LAN/WLAN standards developed by working group 11 of the IEEE LAN/MAN Standards.

The term ‘Terrain elevation data’ refers hereinafter to a digital terrain map, consisting of ground heights as grid points h_{q}(x, y).

The term ‘clutter map’ refers hereinafter to the ground cover of artificial and natural obstructions as a distribution of grid points, h₀(x,y), for built-up areas this is the buildings' overlay profile F(z₁,z₂); the average length or width of obstructions, [symbol] or [symbol] ; the average height of obstructions in the test area, h̅, according to (2.16); the obstructions density per km², ν.

The term ‘effective antenna height’ refers hereinafter to the antenna height plus a ground or obstruction height, if the antenna is assembled on a concrete obstruction: z₁ and z₂ for the transmitter and receiver, respectively.

The term ‘bit error rate (BER)’ refers hereinafter to the ratio of bits received with errors to the total number of bits transmitted (expressed as a fraction or percent). The term ‘Grade of service’ is the probability of a call in a circuit group being blocked or delayed for more than a specified interval, expressed as a vulgar fraction or decimal fraction. This is with reference to the busy hour when the traffic intensity is the greatest. Grade of service may be viewed independently from the perspective of incoming versus outgoing calls, and is not necessarily equal in each direction or between different source-destination pairs.

The term ‘Quality of service’ which Criteria for mobile quality of service in cellular telephone circuits include the probability of abnormal termination of the call, and signal to noise ratio (SNR).

The term ‘link budget’ refers hereinafter to the accounting of all of the gains and losses from the transmitter, through the medium (free space, cable, waveguide, fiber, etc.) to the receiver in a telecommunication system. It takes into account the attenuation of the transmitted signal due to propagation, as well as the loss, or gain, due to the antenna. Random attenuations such as fading are not taken into account in link budget calculations with the assumption that fading will be handled with diversity techniques.

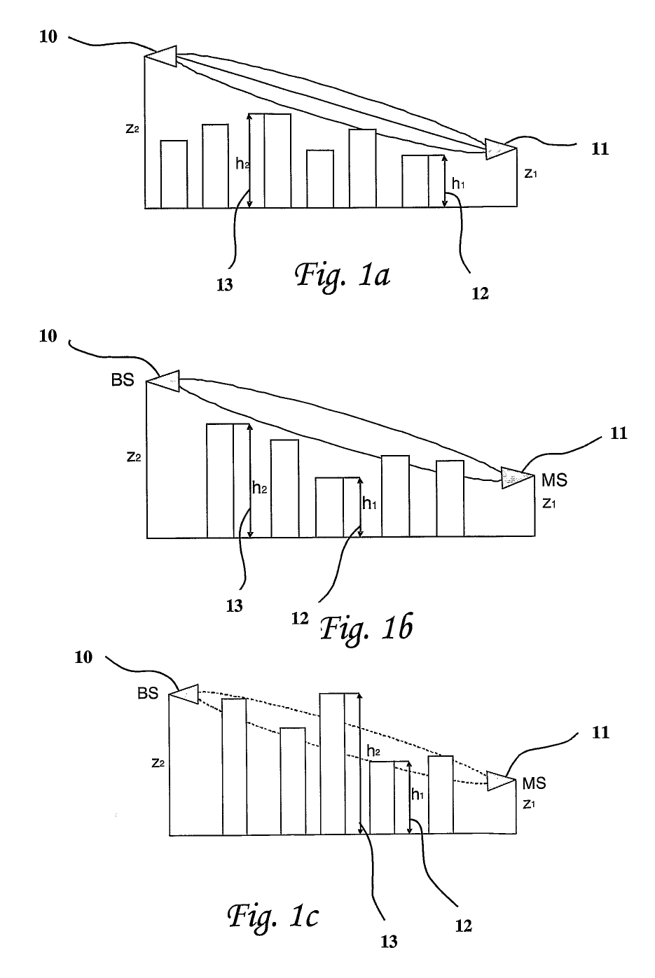

Reference is now made to FIG. 1a. This scenario describes a Quasi-LOS condition between base station (BS) 10 and mobile station (MS) 11 located in an suburban environment. The highest building 13 is marked by height h₂ and the lowest building in the area 12 is marked by height h₁. The total path loss (in dB) can be presented in the following manner: //

$$\begin{matrix}{L}_{1} ( r ) = - 32.4 - 20 log {f}_{[ MHz ]} - 20 log {r}_{[ km ]} - {L}_{fading} + ( {G}_{BS} + {G}_{MS} ) \\ Where & ( 8.1 ) \\ {L}_{fading} = 10 log [ {γ}_{0} r \frac{F ( {z}_{1} , {z}_{2} )}{{h}_{2} - {h}_{1}} ] = 10 log [ {γ}_{0} r \frac{F ( {z}_{1} , {z}_{2} )}{Δ h} ] & ( 8.2 )\end{matrix}$$

Where h₁ and h₂ are the minimum and maximum heights of built-up terrain in meter.

r is the range between the terminal antennas in km.

z₂ and z₁ are the heights of the BS and MS antennas, respectively.

γ₀=2 L̅v/π is the buildings' contour density in km⁻¹.

L̅ is the average length of buildings in km.

v is the number of buildings for square kilometer.

G_{BS} and G_{MS} are the antenna gains for the BS and MS, respectively.

$${γ}_{0} ∈ [ 5 \cdot {10}^{- 3} , 10 \cdot {10}^{- 3} ] [ \frac{1}{m} ] .$$

The value is dependent on the density of the area buildings. Function F (z₁, z₂) [in meter] describes the buildings' overlay profile surrounding two terminal antennas. It can be evaluated for two typical cases:

$$F ( {z}_{1} , {z}_{2} ) = \{ \begin{matrix}( {h}_{1} - {z}_{1} ) + \frac{Δ h}{n + 1} , & {h}_{1} > {z}_{1} , {z}_{2} > {h}_{2} > {z}_{1} \\ \frac{{( {h}_{2} - {z}_{1} )}^{n + 1}}{( n + 1 ) {( Δ h )}^{n + 1}} , & {h}_{1} < {z}_{1} , {z}_{2} > {h}_{2} > {z}_{1}\end{matrix} \qquad ( 8.3 )$$

For urban areas with approximately equal amount of tall and small buildings n=1; when the number of tall buildings prevail (Manhattan-grid plan) n=0.1-0.5; when the number of small buildings prevail (sub-urban and residential areas) n=5-10. In most Israeli's cities n=1 is a very precise value. In the city of Lisbon, for example, this value varied from 0.89 to 1.17, so, also close to n=1. Therefore, it is proposed to use n=1 for areas which are not the same as Manhattan-grid scenario. In the case of n=1, the average building height equals:

$$\overline{h} = {h}_{2} - \frac{n}{n + 1} ( {h}_{2} - {h}_{1} ) = \frac{( {h}_{2} + {h}_{1} )}{2} \qquad ( 8.4 )$$

Reference is now made to FIG. 1b. The second scenario describes a Non-LOS Conditions with Single Diffraction from a roof close to the MS antenna 11 which is a source of shadowing and the slow fading effect. The link loss function of this scenario is:

$$\begin{matrix}{L}_{2} ( r ) = - 32.4 - 30 log {f}_{[ MHz ]} - 30 log {r}_{[ km ]} - {L}_{fading} + ( {G}_{BS} + {G}_{MS} ) \\ and & ( 9.1 ) \\ {L}_{fading} = 10 log \frac{{γ}_{0} {l}_{v} {F}^{2} ( {z}_{1} , {z}_{2} )}{{\vert Γ \vert [ \frac{λ r}{4 {π}^{3}} + {( {z}_{2} - \overline{h} )}^{2} ]}^{1 / 2}} & ( 9.2 )\end{matrix}$$

F²(z₁,z₂)=( h̅−z₁)²

lᵥ is the parameter of walls' roughness, usually equals 1 m to 3 m

|Γ| is the absolute value of reflection coefficient.

|Γ|=0.4 for glass.

|Γ|=0.5-0.6 for wood

|Γ|=0.7-0.8 for stones

|Γ|=0.9 for concrete.

The wavelength of radio wave is varied at the wide range of λ=0.05-0.53 m to cover usually used modern wireless networks. Formula (2.9) with formula (2.10) can be used for link budget design for various parameters of the built-up terrain, for different minimum and maximum building heights, h₁ and h₂ with the average height of buildings,

$$\overline{h} = \frac{( {h}_{2} + {h}_{1} )}{2} ,$$

in the “cell” of computation and for the various BS and MS antenna heights, z₁ and z₂.

Reference is now mad to FIG. 3 depicting a scenario of Non-LOS Conditions with Multiple Diffraction resulting from roofs close to the MS 11 antenna and BS antenna 12 which are the sources of shadowing and the slow fading phenomena. The link loss function for this case is:

$$\begin{matrix}{L}_{3} ( r ) = - 41.3 - 30 log {f}_{[ MHz ]} - 30 log {r}_{[ km ]} - {L}_{fading} + ( {G}_{BS} + {G}_{MS} ) \\ and & ( 10.1 ) \\ {L}_{fading} = 10 log \frac{{γ}_{0}^{4} {l}_{v}^{3} {F}^{4} ( {z}_{1} , {z}_{2} )}{λ {\vert Γ \vert}^{2} [ \frac{λ r}{4 {π}^{3}} + {( {z}_{2} - \overline{h} )}^{2} ]} & ( 10.2 )\end{matrix}$$

Here all parameters are the same, as above, and are measured in meter. The profile function for the urban scene case is:

$$F ( {z}_{1} , {z}_{2} ) = \{ \begin{matrix}( {h}_{1} - {z}_{1} ) + \frac{{( Δ h )}^{2} - {( {h}_{2} - {z}_{2} )}^{2}}{2 Δ h} , & {h}_{1} > {z}_{2} , {h}_{2} > {h}_{1} > {z}_{1} \\ \frac{{( {h}_{2} - {z}_{1} )}^{2} - ( {h}_{2} - {z}_{2} )}{2 ( Δ h )} , & {h}_{1} < {z}_{2} , {h}_{2} > {h}_{1} > {z}_{1}\end{matrix} \qquad ( 10.3 )$$

The equation 10.2 and 10.3 are usable to determine the link budget of this case by using the minimum and maximum heights of buildings, h₁ and h₂, respectively, with the average height of buildings

$$\overline{h} = \frac{( {h}_{2} + {h}_{1} )}{2}$$

in the “cell” of computation and for different antennas heights z₁ and z₂.

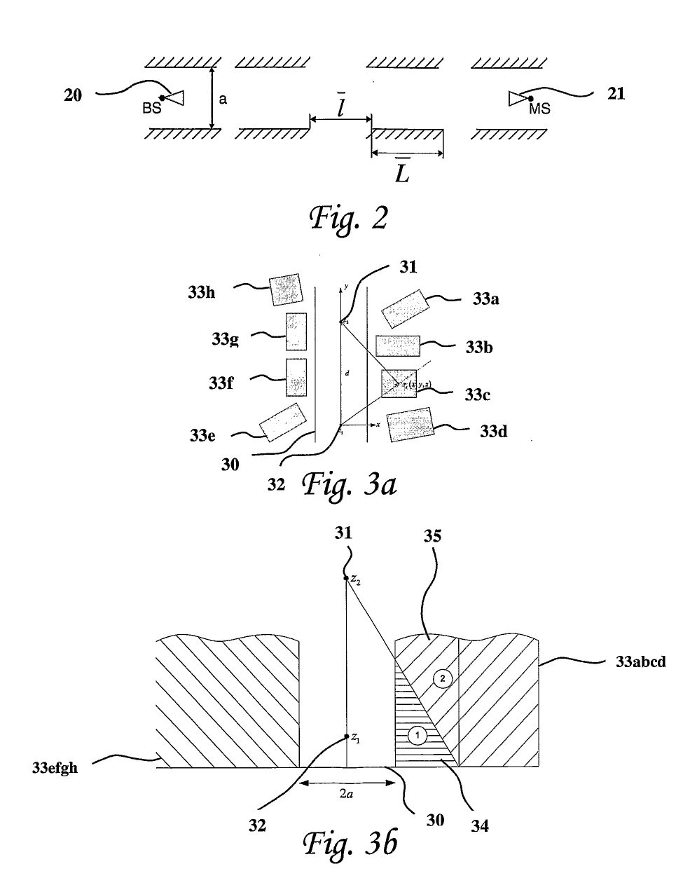

Reference is now made to FIG. 2 depicting a scenario of communication along the street with a link between a BS antenna 20 and an MS antenna 21 lower than the building rooftops. A LOS condition is maintained between MS and BS antennas which are situated along a street at a distance in the range of r=100-1,000 m. The width of the street is a=10-20 m, the wavelength of the wave used is in the range of: λ=0.01-0.05 m, and the parameter of brokenness X= L̅/( L̅+ l̅), where L̅ and l̅ are the average length of slits and buildings depicted in FIG. 2 lining on the street, In an urban scene, such as Manhattan-grid plan with crossing straight streets.

The antennas in this scene are lower or comparable with average buildings' height. In this situation in the urban scene the total path loss is:

$${L}_{5} = - 32.4 - 20 log {f}_{[ MHz ]} - 17.8 log {r}_{[ km ]} - 8.6 \vert ln X \vert \frac{λ r}{2 {a}^{2}} + 20 log \frac{( 1 - X )}{( 1 + X )} + ( {G}_{BS} + {G}_{MS} ) \qquad ( 11.1 )$$

Reference is now made to FIG. 3a depicting a communication link along a street with BS antenna 31 and MS antenna 32. Buildings 33a, 33b, 33c and 33d are located on one side of the street. Buildings 33e, 33f, 33g and 33h are located on the other side of the street. BS station antenna is below the rooftops. In this case, the base station (BS) antenna 31 with the height z₂, is higher than buildings' overlay profile maximum height h₂, MS antenna 32 has a height with the height z₁ is lower than h₂.

In this case, the effect of building array which is randomly distributed at the terrain must be taken into account by use the proposed stochastic approaches. However, the effects of building sections lining the street which are in a proximity to the street have to be taken into account.

Reference is now made to FIG. 3b which is a vertical cross section of the situation in FIG. 3a. BS antenna 31 is higher than the buildings' 33abcd and 33efgh roof tops alongside the street 30. MS antenna 32 is lower than the buildings' roof tops. Reflections of radio waves from Buildings' section 35 which are remotely located from the communication link, are calculated by the stochastic approach and the expressions used for the scenarios depicted in FIG. 1a and FIG. 1b. An added term, which accounts for effects of buildings lining the street in area 34, has to be entered into the calculation.

L_{fading} is calculated by for buildings' area 35 by the following expression:

$${L}_{fading} = 10 log [ {γ}_{0} r \frac{F ( {z}_{1} , {z}_{2} )}{{h}_{2} - {h}_{1}} + ln ( π \frac{k {l}_{v} \overline{h}}{2 a} ) ] \qquad ( 12.1 )$$

where

h̅ is the average buildings' height in meter.

lᵥ is the parameter of roughness of buildings' walls (usually lᵥ=1-3 m.

k=2π/λ.

The following expression is used for calculating link loss for buildings' area 34:

$${L}_{fading} = 10 log [ \frac{{γ}_{0}^{4} {l}_{v}^{3} {F}^{4} ( {z}_{1} , {z}_{2} )}{λ {\vert Γ \vert}^{2} [ \frac{λ r}{4 {π}^{3}} + {( {z}_{2} - \overline{h} )}^{2} ]} + ln ( π \frac{k {l}_{v} \overline{h}}{2 a} ) ] \qquad ( 12.2 )$$

Based on link budget and the total path loss predictions of various outdoor radio communication links, obtaining a radio pattern of a given service area is straight forward.

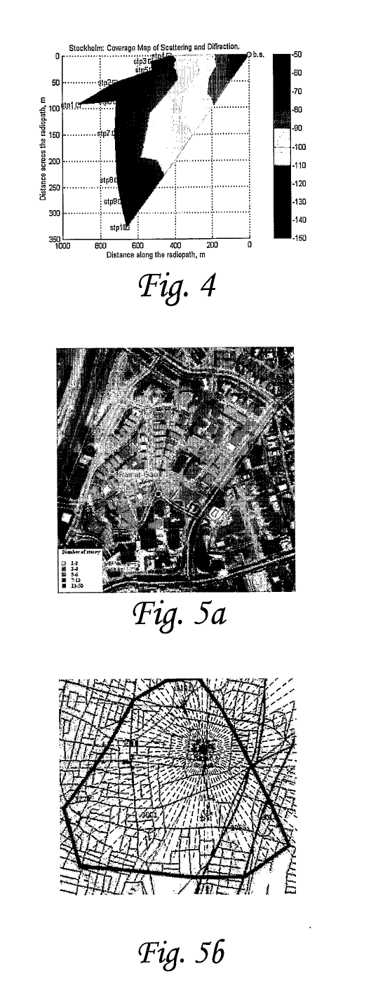

Reference is made now to FIG. 4 which is a radio map of the city of Stockholm. This map is mathematically derived based on the topographic built-up map of the area of service and the enhanced multi-parametric stochastic derivation of the present invention, described in the preceding sections. Experimental radio wave intensity measurements indicate substantial low deviations from the calculated results of the enhanced stochastic model of the present invention (3 db-4 db), whereas results obtained from the stochastic model presently available commercial systems show higher deviations between the measured and the calculated intensity of the radio waves(8 db-9 db). Furthermore, deviation between calculated values and measured experimental values can be as high as 10 db-15 db the Hata model or the Walfish-Ikegami approach, are used for the analysis.

Reference is made now to FIG. 5a illustrating an aerial view of the Israeli diamond exchange center in Ramat Gan depicting a tall buildings which are densely populated in an urban center.

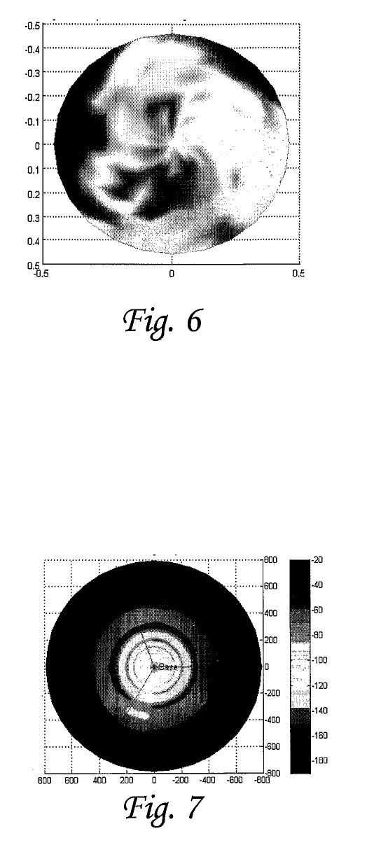

Reference is made now to FIG. 5b. depicting a buildings site map. A black circle marks the location of the BS and radial dashed lines coming out of the BS mark communication links between the BS and any MS in the site area. The average number of buildings per km² in the site area are determined as well as the average length and width related to the direction of the main loop antenna orientation physical data further includes average buildings' height along radial sections of 5° apart. Reference is made now to FIG. 6 depicting a 3D surface representing the function of γ₀ is calculated by an embodiment of the present invention and derived from the measurements of the site building. A link budget evaluation is used by the stochastic analysis of an embodiment of the present invention. The analysis is based on path loss and fading in the specific test-site area with specific topographic features of built-up terrain and evaluations of base station and mobile subscriber antenna.

The Ramat-Gan diamond exchange stock area is a very dense area, which is characterized as a typical “Down-Town” dense area with tall buildings. The antenna characteristics, such as “sector”, tilt, height (z₂), effective power (“Eff”) and gain (“G”), as well as the terrain parameters, such as γ₀, the distance d between BS and MS, and step Δd along the radio path between BS and MS used for this simulation are presented in Table 3.1.

The first column includes angle values of a sector referenced to the north direction.

TABLE 3.1

| | | | | | Tilt | | |
|---|---|---|---|---|---|---|---|
| Sector | γ₀ (gamma) | z₂ | d | Δd | (α) | Eff | G |
| [deg] | [m⁻¹] | [m] | [m] | [m] | [deg] | [dB] | dBi |
| 90 | 10e−3 | 50 | 200 | 5 | 4 | 8.8 | 12.5 |
| 220 | 10e−3 | 50 | 1500 | 20 | 6 | 8.8 | 12.5 |
| 330 | 10e−3 | 50 | 500 | 10 | 4 | 8.8 | 12.5 |

The simulation was derived by the embodiment of the present invention using the following fixed value parameters::

$${z}_{1} = 2 [ m ] ;$$

$${l}_{v} = 2 [ m ] ;$$

$${f}_{0} = 900 [ MHz ] ;$$

$$\vert Γ \vert = 0.7 - 0.8 ;$$

$$λ = \frac{3 \cdot {10}^{8}}{{f}_{0}} \approx 0.33 [ m ] .$$

Reference is now made to FIG. 7 depicting a radio map of the diamond exchange stock area depicting a 3D surface which represents the pass loss function in db a cross the site area. The pass loss function is structured as concentric rings of constant pass loss values implying a radial symmetry of the function. Since the BS antenna was elevated above the built-up profile with the average building of h̅=18.3 m. at ranges close to BS antenna (100-300 m) the path loss is varied from −100 dBm to −120 dBm, whereas far from BS antenna (at 500-800 m) it varies from −150 dBm to −180 dBm. One typical scenario of the communication link includes a BS antenna and an MS antenna that are situated in a built-up area with a high density of irregularly distributed buildings so that the law of signal power decay is changed with distance d between antennas from ˜d^{-γ} (γ=2) before the break point r_{B} (where the coherent part of total field is predominant) to ˜d^{-γ} (γ=2.5-4) beyond the break point r_{B} (where the incoherent part of total field is predominant). In this scenario it is preferable to obtain the minimum cell size, R_{cell}, defined as the break point r_{B}, in various cities with different crossing-street grid plans. For an urban areas with a rectangular grid plan of straight crossing streets, when the multi-slit street waveguide model described in a preceding section, the cell size can be described by the following expression, disregarding effects of diffraction from building corners:

$${R}_{cell} ≡ {r}_{B} = \frac{4 {h}_{T} {h}_{R}}{λ} \frac{( 1 + χ )}{( 1 - χ )} \frac{⌊ 1 + {h}_{b} / a + {h}_{T} {h}_{R} / {a}^{2} ⌋}{{\vert {R}_{n} \vert}^{2}} \qquad ( 13.1 )$$

When information of street geometry is used, such as the street width a, the average height of buildings h_{b} and the mean gaps between buildings lining the street, i.e., the parameter of brokenness X, as well as about both antennas height, h_{T} and h_{R}, and the building walls' material, which determines by the absolute value of reflection coefficient Rₙ, the cell radius along the crossing streets can be obtained. In the case of built-up areas with non-regularly distributed buildings placed on rough terrain, consisting of hills, buildings and other obstructions located in residential zones, cell size is obtained by using the probabilistic approach according to the multi-parametric stochastic model which is an embodiment of the present invention. The average distance of the direct visibility ρ̅ between two arbitrary points, the source and the observer, is described by the following expression:

ρ̅=(γ₀γ₁₂)⁻¹ (km) (13.2)

γ₁₂ is dimensionless parameter characterizing the effects of buildings' overlay profile, 0<γ₁₂≦1 and γ₀=2 L̅v/π (km⁻¹) is the 1-D density of buildings' contours. For a uniform distribution of buildings' heights, when γ₁₂=1, the expression is simplified as:

$$\overline{ρ} = {( {γ}_{0} )}^{- 1} = \frac{π}{2 {\overline{L}}_{v}} ( km ) \qquad ( 13.3 )$$

Using the corresponding topographic built-up maps, the information about servicing areas, i.e., about the buildings' overlay profile with parameters of building overlay heights' pattern n and their average height h̅ and about average buildings' length L̅, as well as the density of buildings per square kilometer, the cell radius within the tested area can be calculated.

The derivation of minimum cell radius of different built-up areas with various situations of the terminal antennas, BS and MS, from specific scenarios in a land communication environment, in one embodiment of the present invention provides a general solution unlike the approach of commercially available systems that are based on two-ray model both for LOS and NLOS conditions.

The maximum cell radius based on the definition of Ricean K-factor and the corresponding evaluation of this parameter can be also evaluated as following:

a) for mixed residential areas with vegetations:

$$\begin{matrix}K = \frac{Ico}{Iinc} \\ = \frac{exp {\{ - {γ}_{0} \cdot d \frac{\overline{h} - {z}_{1}}{{z}_{2} - {z}_{1}} \} [ \frac{sin ( k \cdot {z}_{1} {z}_{2} / d )}{2 π d} ]}^{2}}{\begin{matrix}\frac{Γ}{8 π} \cdot \frac{λ \cdot {l}_{h}}{{λ}^{2} + {[ 2 π {l}_{h} {γ}_{0} ]}^{2}} \cdot \frac{λ \cdot {l}_{v}}{{λ}^{2} + {[ 2 π {l}_{v} {γ}_{0} ( \overline{h} - {z}_{1} ) ]}^{2}} \cdot \\ \frac{{[ {( λ d / {π}^{3} )}^{2} + {( {z}_{2} - \overline{h} )}^{2} ]}^{1 / 2}}{{d}^{3}}\end{matrix}}\end{matrix} \qquad ( 13.4 )$$

b) for the urban and sub-urban environments:

$$\begin{matrix}K = \frac{Ico}{{Iinc}_{1} + {Iinc}_{2}} \\ = \frac{exp \{ - {γ}_{0} d \frac{( {z}_{1} - \overline{h} )}{( {z}_{2} - {z}_{1} )} \} \frac{{sin}^{2} ( k \cdot {z}_{1} {z}_{2} / d )}{4 {π}^{2} {d}^{2}}}{\begin{matrix}\frac{Γ \cdot λ \cdot {{l}_{v} [ ( λ d / 4 {π}^{3} ) + {( {z}_{2} - \overline{h} )}^{2} ]}^{1 / 2}}{8 π [ {λ}^{2} + {( 2 π {l}_{v} {γ}_{0} \cdot ( {z}_{1} - \overline{h} ) )}^{2} ] {d}^{3}} \cdot \\ \frac{{Γ}^{2} {λ}^{3} {l}_{v}^{2} [ {( λ d / 4 {π}^{3} )}^{2} + {( {z}_{2} - \overline{h} )}^{2} ]}{24 {{π}^{2} [ {λ}^{2} + {( 2 π \cdot {l}_{v} \cdot {γ}_{0} \cdot ( {z}_{1} - \overline{h} ) )}^{2} ]}^{2} {d}^{3}}\end{matrix}}\end{matrix} \qquad ( 13.5 )$$

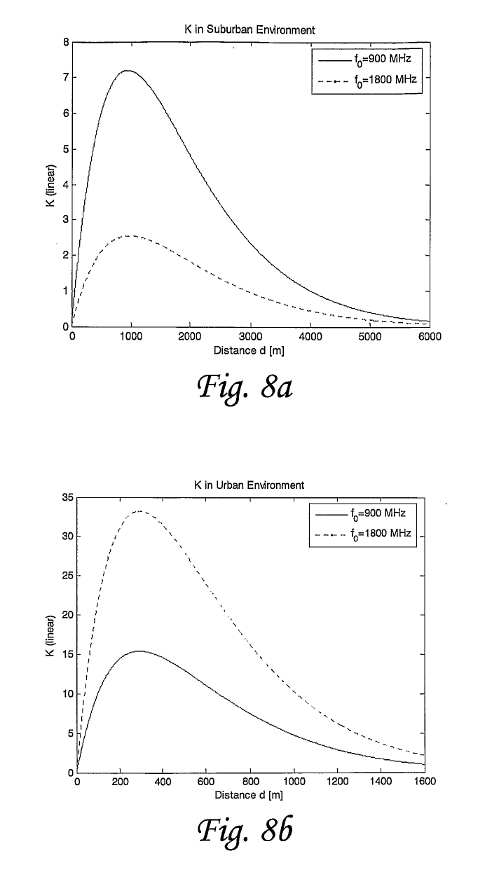

Reference is made now to FIG. 8a depicting K-factor as a function of distance in meters for f=900 MHz and 1800 MHz in a suburban environment. The maximum radius of cell can be determined by maximum of the K function versus the distance. According to the graph of the K function the maximum cell radius at 900 MHz frequency is about 1.0-1.2 km, whereas a direct calculation for the same conditions results for the minimum cell radius value of 570 m.

Reference is now made to FIG. 8b for cell radius 250 m and 400 m respectively, depicting K-factor as a function of distance for f=900 MHz and 1800 MHz in an urban environment. The same computations made for urban area at the same frequencies, yields a maximum cell radius of about 320-350 m, whereas for the same conditions yield a value of minimum radius is about 170-180 m.

Experiments carried out in both areas showed that the stable communication between BS and any user located in area of service can be achieved for the mixed area up to 1 km and for an urban area is about 400-450 m. These results indicate that deriving minimum cell radius and maximum cell radius by K-parameter an embodiment of the present invention can a-priory predict the cell radius of the area where stable communication between users and BS antenna can be achieved.

Cell radius can be also obtained from the maximum link budget by calculating fast fading, according to the model of the present invention. In the scenario depicted in FIG. 6, the analysis for link budget design and K-factor derivation for radio waves propagation in this scenario indicates an attenuation loss related to slow fading changing from 7.1 to 7.2 dB, which is substantially stable within the range between the BS and MS antennas. However, the probability to obtain this loss level is changed from about 0.4 at the range of 100 m from the BS station to about 0.9 at the range of 500 m from the BS.

The derivation of attenuation loss due to fast fading yields approximately 32 dB at the range of 100 m from the BS antenna and approximately 42 dB at the range of 500 m from the BS antenna with the probabilities of 0.7 and about 1, respectively. According to the derivations above for link budget design of the same area, the total loss is changed from about 105 dB at the distance of 100 m to about 140 dB at the distance of 500 m. Considering an acceptable path loss of the system to be 138 dB, the maximum radius of the cell should not exceed 420 m. This result complements the results obtained by the K-factor analysis of the preceding section yielding a minimum cell radius of: Rₘᵢₙ≈320 m. The maximum radius: Rₘₐₓ≈420 m is accounting for a maximum acceptable signal loss with the corresponding probabilities of fast and slow fading. This radius is larger than the minimum one, but substantially equivalent to the BS maximum radius of about 400-450 m derived experimentally.

It is evident that whether using the K-factor of fast fading with the probability and the respected loss, or whether using the maximum accepted path loss with the slow and fast fading, with their respected probabilities and loss, the analysis according to the model of the present invention yields more accurate results than the models of link analysis of presently available systems. More accurate results allow designers of cellular maps to utilize better the range of each BS in the network by having to reserve less in the design.

Another analysis based on radio wave propagation in different built-up areas can be determines the co-channel interference parameter C/I described in a preceding section. Cell sites located beyond the break point ranger r_{B}, can be present the carrier-to-interference ratio: C/I, taking into account multi-path conditions and obstructions which change the signal decay law from D⁻² to D^{-γ}, γ=2+Δγ, Δγ≧1. C/I ratio expression becomes:

$$\frac{C}{I} = 10 log [ \frac{1}{6} ( \frac{{D}^{( 2 + Δ γ )}}{{R}_{cell}^{2}} ) ] \qquad ( 14.1 )$$

The cellular map is derived by an embodiment of the present invention. The decay of signal strength is slower within a cell having a path-loss slope parameter γ=2 of free space. The decay of signal strength is faster in regions outside the servicing cell due to obstructions. Therefore, when the number of cells in cluster is N, and the radius of the individual cell, R_{cell}

The reuse factor Q=D/R_{cell}\sqrt{3N}

And,

$$\frac{C}{I} = 10 log [ \frac{N}{2} {( 3 N )}^{\frac{Δ γ}{2}} {R}_{cell}^{Δ γ} ] \qquad ( 14.2 )$$

In a case of typical crossing straight wide avenues, for which according to multi-slit street waveguide model γ=4, we get:

$$\frac{C}{I} = 10 log [ \frac{3}{2} {( N )}^{2} {R}_{cell}^{2} ] \qquad ( 14.3 )$$

In a case of propagation over irregular built-up terrain, as follows from the stochastic multi-parametric approach, presented above, Δy=1 and the expression for C/I-ratio becomes:

$$\frac{C}{I} = 10 log [ \frac{N}{2} {( 3 N )}^{1 / 2} {R}_{cell} ] \qquad ( 14.4 )$$

C/I-ratio strongly depends on conditions of wave propagation within the urban communication channels and on the cellular map splitting strategy. C/I performance is enhanced if the cell radius R_{cell} is within the break point range and the reuse distance D is beyond this range.

Interference constraint discussed in a subsequent section, which is proportional to the expression:

P_{Ri} ∝ P_{Ti}d^{-γ}, wherein

γ=2.5-3.0

Based on the model of the present invention:

$${\sum }_{j ∈ {M}_{i}} \frac{{P}_{Tj} {d}_{ij}^{- γ}}{{P}_{Ti} {R}_{i}^{- γ}} + {\sum }_{k = 1}^{n} {adj\_factor}_{k} {\sum }_{j ∈ {M}_{i}} \frac{{P}_{Tk} {d}_{ik}^{- γ}}{{P}_{Ti} {R}_{i}^{- γ}} \leq β \qquad ( 15.1 )$$

Expressing the path loss L as a function of the propagation path d and the radiated frequency f, i.e., L (d, f), we present the expression of co-channel interference constraint becomes:

$${\sum }_{j ∈ {M}_{i}} \frac{{P}_{Tj} L ( {d}_{ij} , f )}{{P}_{Ti} L ( {R}_{i} , f )} + {\sum }_{k = 1}^{n} {adj\_factor}_{k} {\sum }_{j ∈ {M}_{i}} \frac{{P}_{Tk} L ( {d}_{ik} , f )}{{P}_{Ti} L ( {R}_{i} , f )} \leq β \qquad ( 15.2 )$$

The efficiency of the analysis model in an embodiment of the present invention is higher than the efficiencies of the Walfisch-Ikegami propagation model (WIM) with slope-attenuation parameter

γ=2.6, as well as with the “flat terrain” model with slope-attenuation γ=4.0 when using an embodiment of the present invention with slope-attenuation parameter of: γ=3.0, for urban and sub-urban scenes. The effects of these three models can be compared by comparing the laws of propagation loss based on strategy of frequency assignment. The interference effects of first (n=1) and second (n=2) adjacent channels in computations, is taken into account. During computations, only co-channel interference (n=0) are considered, as well as a practical example of a 21 cells network. The cells' radii are considered by varying them without changing the base stations' locations in order to produce the following three different configurations:

a) non-overlapping cells;

b) Adjacent cells;

c) Overlapping cells.

Finally, the frequency assignment span and order, which guarantees a CIR of at least 18 dB at every point of the network in urban environment, are computed.

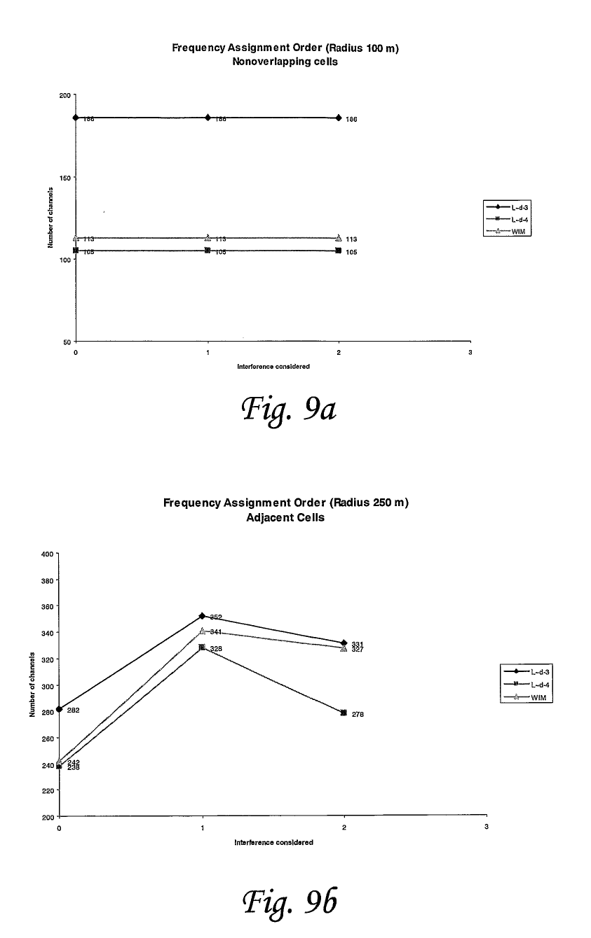

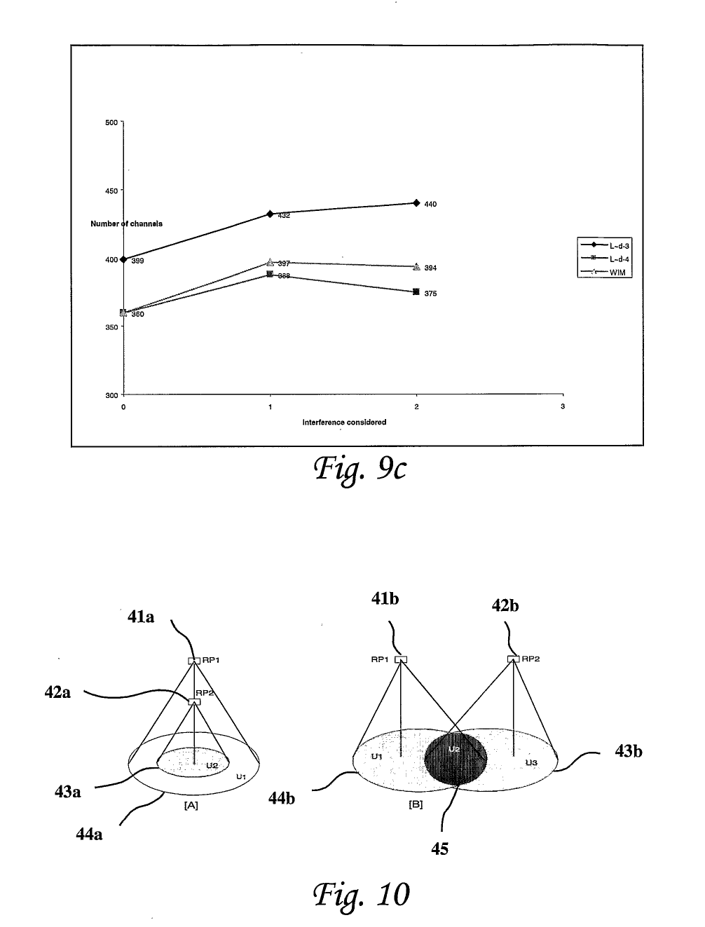

Reference is made now to FIG. 9a depicting a graph of number of channels as a function of number of interferences for a case of non-overlapping stations for a cell radius of 100 m and for three analysis models. The Graph labeled: Ld3 derived by an embodiment of the present invention apparently indicates the highest performance in terms of number of channels as a function of interferences.

Reference is now made to FIG. 9b depicting a graph of number of channels as a function of interferences for cell radius of 250 m and the case of adjacent cells. The Graph labeled: Ld3 derived by an embodiment of the present invention apparently indicates the highest performance in terms of number of channels as a function of interferences, yet the difference between the graphs derived by the three analysis methods are smaller than in the previous case.

Reference is now made to FIG. 9c depicting a graph of number of channels as a function of interferences for cell radius of 400 m and the case of overlapping cells. The Graph labeled: Ld3 derived by an embodiment of the present invention apparently indicates the highest performance in terms of number of channels as a function of interferences.

Apparently, the analysis derived by an embodiment of the present invention, yields the efficiency of the network expressed by highest number of channels relative to the number of interferences and this trend is maintained regardless of cell radius or overlapping conditions.

The various examples discussed in the preceding sections provide a solid proof that non-uniform and non-regular cellular networks analyzed according to an embodiment of the present invention also yield more accurate results when compared with results obtained by simpler two-ray models, typically used by commercially available systems This experimental data the analysis model of the present invention can is advantageously be used also for non-uniform cellular maps design and channel assignment and allocation within different land radio networks.

The goal of fixed wireless access (FWA) networks and mobile wireless access (MWA) networks system deployment is minimizing the number of base stations (BS) or radio ports (RP), for cost saving, while attaining a predefined acceptable level of grade of service (GoS) per user. The GOS that a subscriber gets depends on the cell's radio propagation. The link between users to cells is represented in a link matrix that is fixed for static link data and dynamic when consisting of fading effects.

Reference is made now to FIG. 10 depicting two types of BS area coverage when two adjacent BS are involved. The case labeled [A], consists of BS 41a positioned above BS 42a on the same vertical axis. Area 43a is covered by BS 42a while area 44a is covered by BS 41a. Area 43a is also a common coverage area of BS 41a and BS 42a and which is defined the contained scenario.

The case labeled [B] consists of BS 41b and BS 42b located side by side on the same horizontal plane. Area 44b is covered by BS 41b and area 43b is covered by BS 42b. Area 45 which is the intersection of area 44b and area 43b is common to BS 41b and BS 42b and which is defined overlapped scenario.

The following three user selection policies can be considered:
Blind random access (Random), where user selects RP without sensing whether it is busy or not but by random selection.
Shared resources random access with availability sensing where user knows if the RP is free and picks on RP that has more free ports (Min Load).
Selection by signal strength (SS) where service user selects the RP received by higher signal strength.

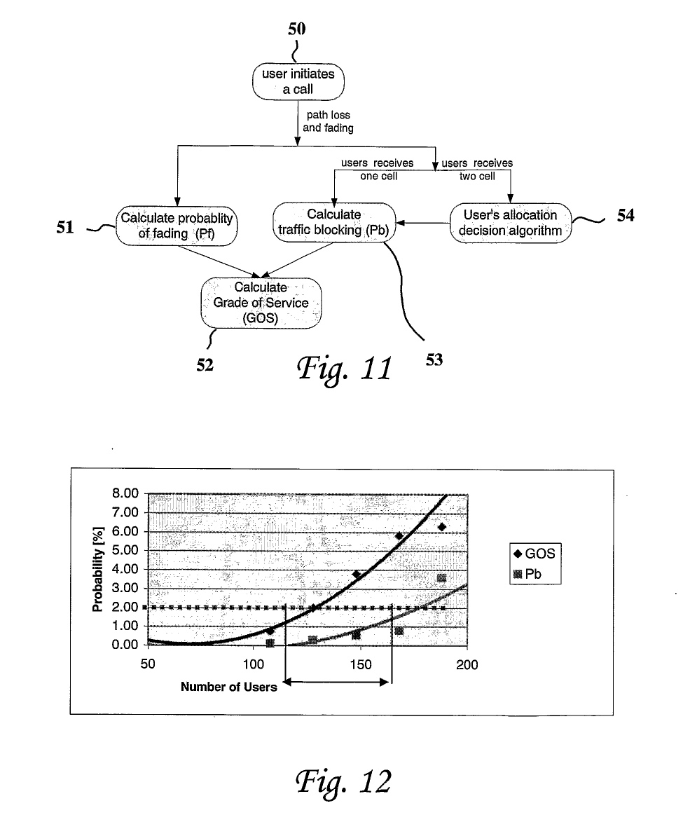

Reference is made now to FIG. 11 depicting a flow chart according to an embodiment of the present invention used to calculate GOS for a given network. Traffic simulation is a comprehensive simulation of two cells with Omni-directional antennas that are deployed in either one of the overlapped or contained scenarios. Groups of users are distributed around the cells and calls are originated according to predefined statistics. Each of the overlapping and contained scenarios is measured A user initiates a call in step 50. In each cell position, the traffic and overlapping parameters are simulated and the user is allocated a channel link is step 54. The blocking probability due to channel congestion P_{b} is calculated in step 53, the probability due to shadowing or slow fading P_{f} is calculated in step 53 and GOS is calculated in step 52, by a convolution of these two probability functions:

GOS=P_{b}·(1−P_{f})+P_{f}·(1−P_{b}) (16.1)

The algorithm, calculates the probability of an unsuccessful call per user that initiates an outgoing call. Traffic simulation generates a table that includes the simulated results for three propagation models and one decision algorithm. In the case of random decision algorithms a probability of 50% is used. The simulation was running for three algorithms for experimenting with a variety of combinations of cases. The simulation has been running seven times for experimenting with a variable number of users.

Reference is now made to FIG. 12 depicting two graphs of GOS and load computation using the same propagation model and algorithm described in the flow chart of FIG. 11. The graph labeled P_{b} demonstrates the probability of blocking due to traffic load as a function of the number of users. The graph labeled GOS demonstrates the quality of service of the network as when considering signal fading. Both graphs are given for one overlapping scenario and each point of the scattered points of this graph represents one simulation with a specific number of users.

The GOS graph shows that if a GOS of 2% is set as a goal, for example, by considering the fading, the load capacity decreases by approximately 50 users compared to the load capacity without fading.

When both slow and fast fading are considered probability of GOS, using the following expression:

GOS=P_{b}·(1−\tilde{P}_{f})+\tilde{P}_{f}(1−P_{b}) (16.2)

### Where

\tilde{P}_{f}=P_{slow}_{_{—}}_{fading}·P_{fast}_{_{—}}_{fading} (16.3)

Value of P_{b} we computed, using classical model of loading computation for different number of users for all three scenarios for connection to the system.

The expressions in the subsequent sections are results numerical simulation for a specific urban area with the following parameters of the terrain and the virtual experiment:

F=10000 MHz, λ=0.33 m; z₁=5 m; z₂=35 m; h₁=10 m; h₂=30 m; (16.4)

Γ=0.7; γ₀=1 km⁻¹; lᵥ=1 m; L̅=10 m; n=1.

Table 1.1 consists of results of a random search (“Random”) search policy, a number of users of n=20 and P_{blocking}=3.15%.

TABLE 1.1

| Random, n = 20 | 0.5 km | 1 km | 1.5 km | 2 km |
|---|---|---|---|---|
| P_{blocking} | 3.15% | 3.15% | 3.15% | 3.15% |
| P_{slow}_{_{—}}_{fading} | 24% | 26% | 27% | 28% |
| P_{fast}_{_{—}}_{fading} | 2.3% | 6.4% | 13.5% | 17.8% |
| GOS | 3.67% | 4.71% | 6.57% | 7.82% |

Table 1.2 consists of results of a predefined search (“Min_Load”) search policy, a number of users is n=20 and P_{blocking}=3.16%.

TABLE 1.2

| Predefined, n = 20 | 0.5 km | 1 km | 1.5 km | 2 km |
|---|---|---|---|---|
| P_{blocking} | 3.19% | 3.19% | 3.19% | 3.19% |
| P_{slow}_{_{—}}_{fading} | 24% | 26% | 27% | 28% |
| P_{fast}_{_{—}}_{fading} | 2.3% | 6.4% | 13.5% | 17.8% |
| GOS | 3.68% | 4.72% | 6.57% | 7.83% |

Table 1.3 consists of results for controlled resources (“SS”) search policy, a number of users n=20 and P_{blocking}=1.8%.

TABLE 1.3

| Controlled, n = 20 | 0.5 km | 1 km | 1.5 km | 2 km |
|---|---|---|---|---|
| P_{blocking} | 1.80% | 1.80% | 1.80% | 1.80% |
| P_{slow}_{_{—}}_{fading} | 24% | 26% | 27% | 28% |
| P_{fast}_{_{—}}_{fading} | 2.3% | 6.4% | 13.5% | 17.8% |
| GOS | 2.33% | 3.40% | 5.31% | 6.60% |

The results of the above tables indicate that by considering only slow fading, which is mostly important in urban and sub-urban areas, increases blocking probability by a factor of 5-8 when the overlapping level is less than 40%. When the overlapping level exceeds 50%, blocking probability increases by factor 2 when considering slow fading.

The parameters SNR, BER, capacity (C) and spectral efficiency (\tilde{C}), discussed in a preceding section, provide quality measures of the transmitted signal along the transmission channel.

In one embodiment of the present invention, the stochastic and multi-parametric model is used in cases of dynamic communication channels with fading, flat or multiplicative, by introducing a multiplicative noise source Nₘᵤₗ.

Nₘᵤₗ is used as noise level related to fading and added to the white noise level of the communication channel in the following expression:

$$C = {β}_{ω} {log}_{2} [ 1 + \frac{S}{{N}_{0} {B}_{ω} + {N}_{mul}} ] \qquad ( 17.1 )$$

This equation is valid when the LOS component of the signal in a channel exceeds the NLOS component, meaning that K-factor exceeds the SNR level. In this case Nₘᵤₗ can be defined as a “Gaussian-like” noise and the expression can be written as following:

$$\begin{matrix}C = {β}_{ω} {log}_{2} [ 1 + \frac{S}{{N}_{add} + {N}_{mul}} ] \\ = {β}_{w} {log}_{2} ( 1 + {( \frac{{N}_{add}}{S} + \frac{{N}_{mul}}{S} )}^{- 1} )\end{matrix} \\ Where \\ \frac{S}{{N}_{add}} = S N {R}_{add} and \frac{S}{{N}_{mul}} = \frac{{I}_{co}}{{I}_{inc}} . \qquad ( 17.2 )$$

Since K is defined as:

$$K = \frac{{I}_{co}}{{I}_{inc}}$$

The capacity is expressed as a function of the K-factor and the additive noise:

$$\begin{matrix}C = {β}_{ω} {log}_{2} ( 1 + {( S N {R}_{add}^{- 1} + {K}^{- 1} )}^{- 1} ) \\ = {β}_{w} {log}_{2} ( 1 + \frac{K \cdot S N {R}_{add}}{K + S N {R}_{add}} )\end{matrix} \qquad ( 17.3 )$$

The spectral efficiency of the channel is also expressed by the same parameters:

$$\tilde{C} = \frac{C}{{β}_{ω}} = {log}_{2} ( 1 + \frac{K \cdot S N {R}_{add}}{K + S N {R}_{add}} ) \qquad ( 17.4 )$$

Where B_{w} is the bandwidth of the communication link.

The above expressions are valid when the K factor is greater than the SNR_{add}. This was also experimentally. In open land communication links, the parameter K typically exceeds 10 dB while in urban and sub-urban areas the SNR_{add} parameter typically does not exceed 8-10 dB. As follows from, where this statement was checked numerically, the classical approach and that based on the stochastic model gives the same capacity up to SNR=10-12 dB for K>15 dB .

Bit Error Rate (BER) expression, defined in the preceding section when including the above multiplicative noise term, becomes:

$$BER ( K , S N {R}_{add} , σ ) = \frac{1}{2} {\int }_{0}^{∞} \frac{x}{{σ}^{2}} \cdot {e}^{- \frac{{x}^{2}}{2 {σ}^{2}}} \cdot {e}^{- K} \cdot {I}_{0} ( \frac{x}{σ} \sqrt{2 K} ) \cdot erfc ( \frac{K \cdot S N {R}_{add}}{2 \sqrt{2} ( K + S N {R}_{add} )} x ) d x \qquad ( 18.1 )$$

σ Is the standard deviation of the signal

p(x) Is Ricean PDF and the SNR includes multiplicative noise

This expression is manipulated by expressing K as a function of C

$$K = \frac{S N {R}_{add} ( {2}^{\frac{C}{{B}_{w}}} - 1 )}{S N {R}_{add} - ( {2}^{\frac{C}{{B}_{w}}} - 1 )} = \frac{S N {R}_{add} ( {2}^{\tilde{C}} - 1 )}{S N {R}_{add} - ( {2}^{\tilde{C}} - 1 )} \qquad ( 18.2 )$$

BER as a function of \tilde{C} becomes:

$$BER ( \tilde{C} ) = \frac{1}{2} {\int }_{0}^{∞} \frac{x}{{σ}^{2}} \cdot {e}^{- \frac{{x}^{2}}{2 {σ}^{2}}} \cdot {e}^{- \frac{S N {R}_{add} ( {2}^{\tilde{C}} - 1 )}{S N {R}_{add} - ( {2}^{\tilde{C}} - 1 )}} \cdot {I}_{0} ( \frac{x}{σ} \sqrt{2 \frac{S N {R}_{add} ( {2}^{\tilde{C}} - 1 )}{S N {R}_{add} - ( {2}^{\tilde{C}} - 1 )}} ) \cdot erfc ( \frac{\frac{S N {R}_{add} ( {2}^{\tilde{C}} - 1 )}{S N {R}_{add} - ( {2}^{\tilde{C}} - 1 )} \cdot S N {R}_{add}}{2 \sqrt{2} ( \frac{S N {R}_{add} ( {2}^{\tilde{C}} - 1 )}{S N {R}_{add} - ( {2}^{\tilde{C}} - 1 )} + S N {R}_{add} )} x ) d x \qquad ( 18.3 )$$

Further manipulation reduce

$$BER ( \tilde{C} ) = \frac{1}{2} {\int }_{0}^{∞} \frac{x}{{σ}^{2}} \cdot {e}^{- \frac{{x}^{2}}{2 {σ}^{2}}} \cdot {e}^{- \frac{S N {R}_{add} ( {2}^{\tilde{C}} - 1 )}{S N {R}_{add} - ( {2}^{\tilde{C}} - 1 )}} \cdot {I}_{0} ( \frac{x}{σ} \sqrt{2 \frac{S N {R}_{add} ( {2}^{\tilde{C}} - 1 )}{S N {R}_{add} - ( {2}^{\tilde{C}} - 1 )}} ) \cdot erfc ( \frac{( {2}^{\tilde{C}} - 1 )}{2 \sqrt{2}} x ) d x \qquad ( 18.4 )$$

This expression relates to the spectral efficiency of the multi-path communication channel with fading, caused by multiple reflection, scattering and diffraction.

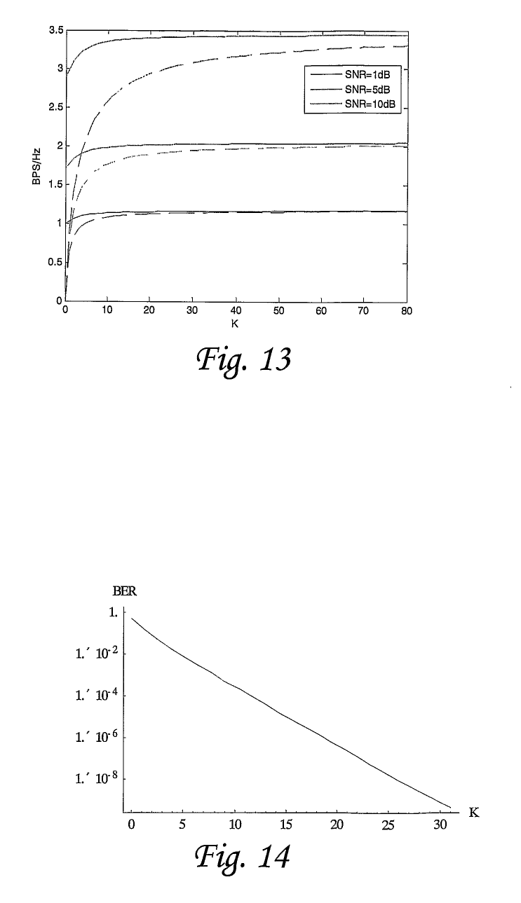

Reference is now made to FIG. 13 depicting graphs of spectral efficiency (channel bandwidth) as a function of the channel propagation conditions (K), with a variable parameter of signal to noise ratio (SNR). SNR includes the multiplicative noise term discussed in a preceding section. The graph show calculated spectral efficiency as a function of K for SNR=1 db, SNR=5 db and SNR=10 db. The graphs indicate that with the increase in SNR from 1 dB to 10 dB the increase in spectral efficiency exceeds factor of 3. The effect is even increased for the worst case of multi-path fading channels, when for K<5.

Reference is now made to FIG. 14 depicting a graph of BER as a function of the channel propagation conditions (K) consisting on the following parameters:

σ=2, SNR_{add}=1 dB. The Graph indicates that when LOS component is predominant relative to the NLOS component, K increases and BER decreases. For example, for K≈5 BER=10⁻² and for K≈20 K=10⁻⁶.

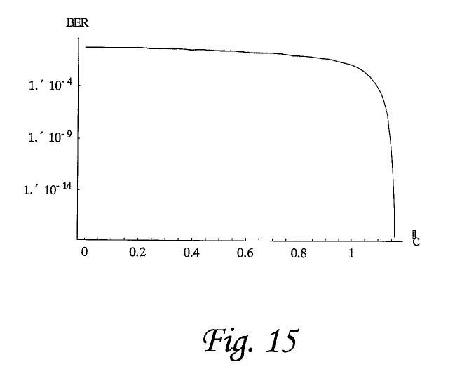

Reference is now made to FIG. 15 depicting a graph of BER as a function of the spectral efficiency consisting on the following parameters:

σ=2, SNR_{add}=1 dB. The Graph indicates that when the spectral efficiency increases above the level of 1 in there is a sharp drop in BER.

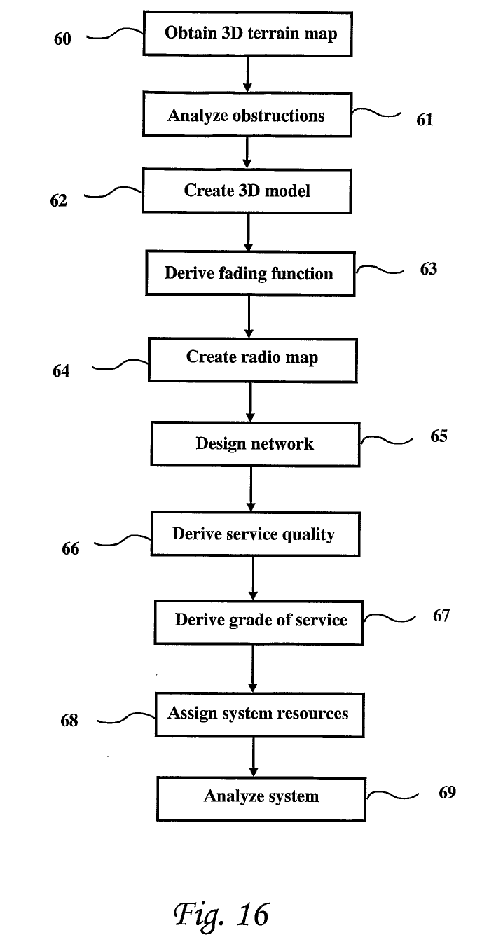

Reference is now made to FIG. 16 depicting the algorithm steps in an embodiment of the present invention. The algorithm is applied in a non limiting manner to wireless networks in terrestrial environments. The algorithm begins with step 60 of obtaining a 3D terrain map of the area that has to be by a network. The purpose of this step is to calculate obstructions. The collected terrain data along and estimated transmitter and receiver parameters are analyzed in step 61 by using theoretical mathematical expressions presented in the preceding section and estimating clearing conditions between BS antenna and MS antenna based on obstruction dimensions and antenna locations. The analysis provides density of building contours on the ground level and clearance conditions between transmitter and receiver. Depending on the density of obstructions and position and elevation of base station antennas the area is divided into an array of indexed sub-sections consisting of calculated indexed parameters. The indexed cell parameters are used in step 62 to create a 3D model for the following three terrain classes: mixed residential areas, sub-urban areas and urban areas. This step generates in the end, a signal average pass loss distribution in the classified environments. Link fading function is derived in step 63. Fading consists of slow fading resulted by shadowing effects of building roofs and corners and fast fading. Fast fading is obtained by combining a LOS coherent component of the signal and incoherent multi-path component with no diffraction. Signal loss function is calculated from the fading data. Alternatively, total pass loss can be computed by link budget calculation, presented in a preceding section. A performance radio map is created in step 64 based on the pre-defined link budget and data of built up terrain and distribution function of buildings in the service area. The wireless network is designed in step 65. The number of cells, the related BS and RP antennas and cells radiation patterns are determined for yielding a substantially homogeneous signal distribution under the given topographic features and buildings overlay profile in the area. The system design step is followed quality of service (QOS) analysis in step 66 by calculating the QOS which is defined as the carrier to interference ratio in a preceding section. Grade of service (GOS) which is another characteristic of quality of a cellular network, defined as the probability of an unsuccessful call for a given number of network subscribers is calculated in step 67. System channels are assigned to each subscriber located in the area in step 68 by regarding multiple access service under calculated signal attenuation conditions in the area of service. Finally, the entire cellular network is analyzed in step 69. The network analysis step derives key network and data stream parameters under given conditions consisting of: Capacity, spectral efficiency and BER.

The above algorithm is operable for calculating wireless network parameters and correlating real conditions in the propagation channels, the parameters of the channels, the parameters of the information data stream and allowing designers of cellular networks to match system design to performance requirements and environment conditions.

The above algorithm is specifically adaptable in one embodiment to a wireless network technology selected from a group consisting of: CDMA, FDMA, TDMA, GSM, UMTS, WCDMA or any wireless technologies thereof.

The above algorithm is specifically adaptable in one embodiment to the 802.11 wireless network technology.

1. A method for designing and analyzing a wireless network located at a terrestrial environments, comprising:
a. creating a 3D stochastic multi-parametric (3DSM) model of a terrain area designated for a wireless network;
b. designing a wireless network operable in said area;
c. analyzing the performance of said wireless network;
wherein creating said 3DSM model of said terrain, is yielding design and analysis parameters of said network that are substantially equal to corresponding parameters obtained by measuring.

2. The method according to claim 1, wherein the step of creating said 3DSM model consists of building overlay profile of obstructions affecting the distribution of scattered radio waves from horizontal and vertical dimensions of said obstructions; wherein said obstructions are selected form a group of structures located within a network area consisting of building, trees, hills, fixed structures or any combination thereof.

3. The method according to claim 1, wherein the step of creating said 3DSM model distribution is provided for mixed residential areas, sub-urban areas, urban areas or any combination thereof.

4. The method according to claim 1, further comprising adding a multiplicative noise term which is used for emulating fading phenomena, to the real white noise term.

5. The method according to claim 1, wherein designing said network comprises calculating minimum cell radius from said 3DSM model.

6. The method according to claim 1, wherein said calculating step of said minimum cell radius follows a calculating step of signal fading.

7. The method according to claim 1, wherein said calculating step of said minimum cell radius follows a calculating step of link path loss.

8. The method according to claim 1, wherein designing said network comprises calculating co-channel interference constraint.

9. The method according to claim 1, wherein designing said network comprises calculating a grade of service (GOS) of said wireless network;

10. The method according to claim 1, wherein said analyzing step comprising calculating said network bit error rate (BER);

11. The method according to claim 1, wherein said analyzing step comprising calculating said network quality of service (QOS);

12. The method according to claim 1 or claim 4, wherein said analyzing step comprising calculating said network capacity;

13. The method according to claim 1 or claim 4, wherein said analyzing step comprising calculating said network spectral efficiency.

14. The method according to any of the above claims wherein any of said calculating steps is substantially matched with real experiments.

15. The method according to claim 1, wherein said step of designing comprises obtaining standard deviation of slow fading, σ_{L}, is performed either for single diffraction and double diffraction scenarios.

16. The method according to claim 1, wherein said step of designing comprises obtaining said fade margin is performed both in the cases of slow and fast fading.

17. The method according to claim 1, adapted for radio mapping by distinguishing areas through attenuation after predicting said attenuation according to parameters selected from a group consisting of terrain elevation data, a clutter map, the effective antenna height, antenna pattern or directivity and its effective radiated power (ERP), operating frequency or any combination thereof.

18. The method according to claim 1, especially adapted for designing of cellular maps.

19. The method according to claim 1, especially adapted to be utilized in a wireless technology selected from CDMA, FDMA, TDMA, GSM, UMTS, WCDMA, or any technologies derived thereof.

20. The method according to claim 1, especially useful for improving channel allocation.

21. The method according to claim 1, especially adapted to 802.11 wireless network or any protocol based on the same.
